(19) United States
(12) Patent Application Publication
(10) Pub. No.: US 2013/0067563 A1
(43) Pub. Date: Mar. 14, 2013

(54) APPARATUS AND METHOD FOR MANAGING PERMISSION INFORMATION OF APPLICATION

(71) Applicants: Se Moon PARK, Seoul (KR); Jae Sung PARK, Seoul (KR); Moo Gun AHN, Seoul (KR)

(72) Inventors: Se Moon PARK, Seoul (KR); Jae Sung PARK, Seoul (KR); Moo Gun AHN, Seoul (KR)

(73) Assignee: PANTECH CO., LTD., Seoul (KR)

(21) Appl. No.: 13/428,968

(22) Filed: Mar. 23, 2012

(30) Foreign Application Priority Data
Sep. 9, 2011 (KR) 10-2011-0091998

(51) Int. Cl. G06F 21/00

(52) U.S. Cl. 726/17

(57) ABSTRACT

A method for managing permission information of an application in a mobile terminal includes detecting a reference event associated the application, determining a type of the reference event, determining permission information of the application, determining whether to execute an operation of the application based on the permission information, and storing operation performance information related to the operation of the application in a database. A terminal includes an application layer to detect an event associated with a change in permission information of a first application and a second application, and a framework layer to determine whether permission information of the first application is changed with respect to the second application, to determine an event type associated with the change in the permission information, to determine permission information of the first application and the second application, and to determine whether to execute a security program.

### CROSS-REFERENCE TO RELATED APPLICATION

This application claims priority from and the benefit under 35 U.S.C. §119(a) of a Korean Patent Application No. 10-2011-0091998, filed on Sep. 9, 2011, which is incorporated herein by reference for all purposes.

### BACKGROUND

1. Field

The following description relates to a smart terminal, and more particularly, to an apparatus and a method for managing permission information of an application in the smart terminal.

2. Discussion of the Background

A conventional method for identifying a malicious application among various applications operating in a smart terminal may include inspecting an operation of each application and providing information about an application that may be operating maliciously.

Typically, prevention of a malicious application may be carried out by analyzing an operation of an application and performing an appropriate action in response.

In an example, user information may be leaked if an unauthorized application operates with respect to an authorized application.

Also, another application may be arbitrarily operated using permissions of a reference application whereby information leakage, charging, and the like may occur. In addition, in the conventional art, it may be difficult to monitor permission information of an application downloaded by a user, or an application arbitrarily changed by a user. Further, it may also be difficult to restrict an operation of the application.

Accordingly, without a user's awareness, an unauthorized application may perform one or more operations not authorized by a user, in which information leakage may occur.

### SUMMARY

Exemplary embodiments of the present invention provide a system and a method for managing permission information of an application.

Additional features of the invention will be set forth in the description which follows, and in part will be apparent from the description, or may be learned by practice of the invention.

Exemplary embodiments of the present invention provide a method for managing permission information of an application in a mobile terminal including detecting a reference event associated the application, determining a type of the reference event, determining permission information of the application, determining whether to execute an operation of the application based on the permission information, and storing operation performance information related to the operation of the application in a database.

Exemplary embodiments of the present invention provide a method for managing permission information including executing a first application, detecting an application execution event associated with a second application, collecting application information of the first application and the second application, determining whether permission information of the first application has changed, receiving an instruction set of a security action for at least one of the first application and the second application, and executing the security action.

Exemplary embodiments of the present invention provide a terminal including an application layer to detect an event associated with a change in permission information of a first application and a second application; and a framework layer to determine whether permission information of the first application is changed with respect to the second application, to determine an event type associated with the change in the permission information, to determine permission information of the first application and the second application, and to determine whether to execute a security program, in which the security program executes a security action based on the event type associated with a change in the permission information.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration of a terminal platform according to an exemplary embodiment of the invention.

FIG. 2 is a block diagram illustrating a configuration of a protection manager according to an exemplary embodiment of the invention.

FIG. 3 is a block diagram illustrating a configuration of a protection application processing unit according to an exemplary embodiment of the invention.

FIG. 4 is a flowchart illustrating a method for managing permission information of an application according to an exemplary embodiment of the invention.

FIG. 5 is a flowchart illustrating a method for analyzing information of an application according to an exemplary embodiment of the invention.

FIG. 6 is a flowchart illustrating a method for analyzing a permission of an application to be executed according to an exemplary embodiment of the invention.

FIG. 7A and FIG. 7B are views illustrating a screen that is displayed on a terminal if an application is terminated according to an exemplary embodiment of the invention.

FIG. 8 is a flowchart illustrating a method for terminating an application according to an exemplary embodiment of the invention.

FIG. 9A and FIG. 9B are views illustrating a screen that is displayed on a terminal if an application is deleted or uninstalled according to an exemplary embodiment of the invention.

FIG. 10 is a flowchart illustrating a method for deleting an application according to an exemplary embodiment of the invention.

FIG. 11 is a flowchart illustrating a method for requesting permission information of an application according to an exemplary embodiment of the invention.

FIG. 12 is a view illustrating a screen that is displayed on a terminal in response to a request for permission information of an application according to an exemplary embodiment of the invention.

FIG. 13 is a view illustrating a screen that is displayed on a terminal if adding or deleting permission information of an application according to an exemplary embodiment of the invention.

FIG. 14 is a flowchart illustrating a method for adding permission information of an application according to an exemplary embodiment of the invention.

FIG. 15 is a flowchart illustrating a method for deleting permission information of an application according to an exemplary embodiment of the invention.

FIG. 16 is a view illustrating a screen that is displayed on a terminal if a suspicious program is to be deleted among applications according to an exemplary embodiment of the invention.

FIG. 17 is a flowchart illustrating a method for deleting a suspicious program among applications according to an exemplary embodiment of the invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

It will be understood that if an element is referred to as being “connected to” another element, it can be directly connected to the other element, or intervening elements may be present.

Exemplary embodiments of the invention describe an example of an embedded system installed in a smart terminal.

The term “application” used herein may refer to an application program without limitation.

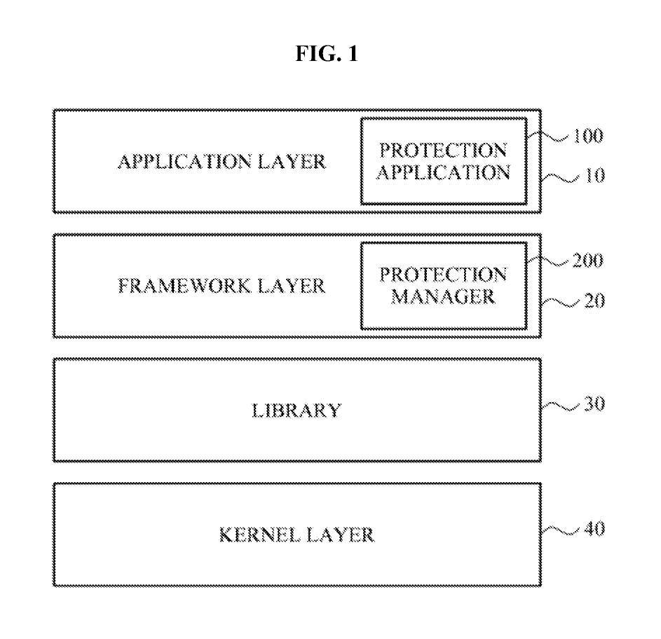

FIG. 1 is a block diagram illustrating a configuration of a smart terminal platform according to an exemplary embodiment of the invention.

Referring to FIG. 1, the smart terminal platform may include an application layer 10, a framework layer 20, a library 30, and a kernel layer 40.

The application layer 10 may provide one or more applications to perform various operations, which may include, without limitation, an e-mail application, a social networking application, a texting application, a phone application, and the like. Also, the application layer 10 may include a protection application processing unit 100. The protection application processing unit 100 may detect one or more events associated with a change in permission information of an executed application. The protection application processing unit 100 may also request to receive a user input related to an operation of the application.

The framework layer 20 may provide one or more components to support application configuration and/or operation. Components provided in the framework layer 20 may include, without limitation, an activity manager, a window manager, a contents provider, a view system, a notification manager, a package manager, a telephony manager, a resource manager, a location manager, an extensible messaging and presence protocol (XMPP) service, and the like. The framework layer 20 may include a protection manager 200. The protection manager 200 may determine whether permission information of an application is changed, as well as one or more causes for the change in the permission information. The protection manager 200 may operate based on a monitoring result and/or a user selection result with respect to an internal system operation.

The kernel layer 40 may manage a core system service associated with at least one of a memory, a network, a security, and a driver.

The library 30 may provide a variety of components used in the application layer 10 and/or the framework layer 20. For example, the components may include, without limitation, a surface manager, a media framework, SQLite, open graphics library for embedded systems (OpenGL ES), FreeType, Webkit, Scene Graph Library (SGL), Secure Sockets Layer (SSL), C Standard Library (libc), and the like.

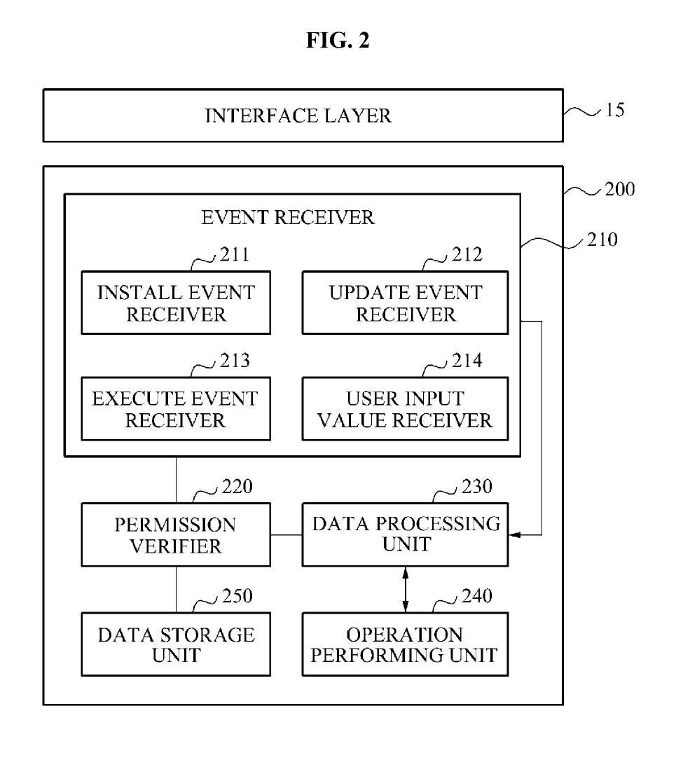

FIG. 2 is a block diagram illustrating a configuration of a protection manager according to an exemplary embodiment of the invention.

Referring to FIG. 2, a protection manager 200 includes an event receiver 210, a permission verifier 220, a data processing unit 230, a data storage unit 240, and an operation performing unit 250.

The protection manager 200 may determine whether permission information of an application is changed. If the permission information is determined to have changed, the protection manager 200 may determine whether the permission information is changed according to a normal procedure or process, such as, normal updates, installs, and the like.

The event receiver 210 may be executed to monitor a variety of events associated with an application.

One or more events may be transmitted to and received from an Intent Object of an Android® platform. In an example, the Intent Object may refer to a bundle of information, which may include information of interest to the component that receives the intent, such as the action to be taken and the data to act on, plus information of interest to the Android® platform, such as a category of component that should handle the intent and instructions on how to launch a target activity.

According to an exemplary embodiment of the invention, it may be possible to detect an occurrence of an event associated with a change associated with an application. Also, it may be possible to detect an occurrence of an event associated with a change in permission information.

As shown in FIG. 2, the event receiver 210 includes an install event receiver 211, an update event receiver 212, an execute event receiver 213, and a user input value receiver 214.

The install event receiver 211 and the update event receiver 212 may receive an event associated with an application, such as installation or update of the application, and may detect a change state of the application.

The execute event receiver 213 may detect an application execution event and may output information associated with an event execution request to the permission verifier 220. In an example, one or more application execution events may be generated in response to execution of an application.

The user input value receiver 214 may receive, from a user, a signal indication that the application and/or permission information associated with the application has been changed. Further, the user input value receiver 214 may also receive an operation control signal of the application in response to the change of the permission information.

The permission verifier 220 may determine whether permission information of the application has been arbitrarily changed, maliciously changed, or changed outside of normal operation of the application. Permission information of the application may be arbitrarily changed if the permission information changes without control or selection from a user or a terminal. Further, the permission verifier 220 may determine whether the permission information is included in a black list. In an example, the black list may refer to a list of permission information arbitrarily operable by one or more applications. Further, the black list may manage a list of operations that are executed by one or more applications. If the permission information of the application has been arbitrarily changed or is included in the black list, the permission verifier 220 may output corresponding instruction information to the operation performing unit 250 and/or the data processing unit 230. The outputted instruction information may include at least one of instruction to terminate the application, suspend the application, delete the application, store the changed permission information, and quarantine the application.

Based on the instruction information received from the permission verifier 220, the operation performing unit 250 may delete the application, terminate the application, suspend the application, quarantine the application, and/or may store the changed permission information.

Further, the event receiver 210 may detect at least one of an application execution event, an application install event, and an application update event. The event receiver 210 may also receive an operation control signal of the application or a signal indicating permission information of the application has changed.

That is, if a second application execute event is detected while the first application is being executed, the permission verifier 220 may determine whether permission information of the first application is changed in association to execution of a second application. If permission information of the first application is changed in association to the execution of the second application, the second application may be determined to be a hacking program that copies permission information of the first application to be used with the second application. Accordingly, the operation performing unit 250 may restrict the operation of the second application.

If the event receiver 210 detects the second application execution event while the first application is being executed, but the permission verifier 220 determines that permission information of the first application has not changed, the permission verifier 220 may determine that the first application and the second application are irrelevant or normal programs that perform normal multitasking.

The data processing unit 230 may read/write data stored in the data storage unit 240. In response to the application execution event and the permission information change event, the data processing unit 230 may update permission information that may be stored in the data storage unit 240.

The data storage unit 240 may store at least one of permission information of the application, and state information associated with operations of the permission verifier 220 and/or the operation performing unit 250.

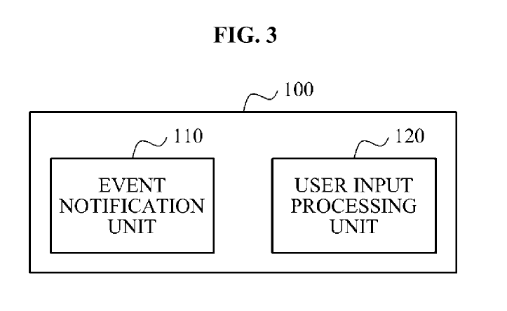

FIG. 3 is a block diagram illustrating a configuration of a protection application processing unit according to an exemplary embodiment of the invention.

Referring to FIG. 3, the protection application processing unit 100 includes an event notification unit 110 and a user input processing unit 120.

The protection application processing unit 100 may communicate with the protection manager 200 of FIG. 2 via the interface layer 15 of FIG. 2.

The interface layer 15 of FIG. 2 may transmit, to the protection application processing unit 100, an operation control signal that may be generated by the protection manager 200.

The event notification unit 110 may detect the application execute event based on a change and/or a restriction in permission information of the application, which may be received from the protection manager 200 of FIG. 2. The event notification unit 110 may also request a corresponding operation of the application to be performed.

The user input processing unit 120 may request to receive a user input related to an operation of an application, and request a designated operation associated with the user input to be performed. Also, the user input processing unit 120 may receive, from the user, a signal to configure permission information of the application, and a signal to access and/or modify an application management list. The management list may be modified or corrected by a user having appropriate access.

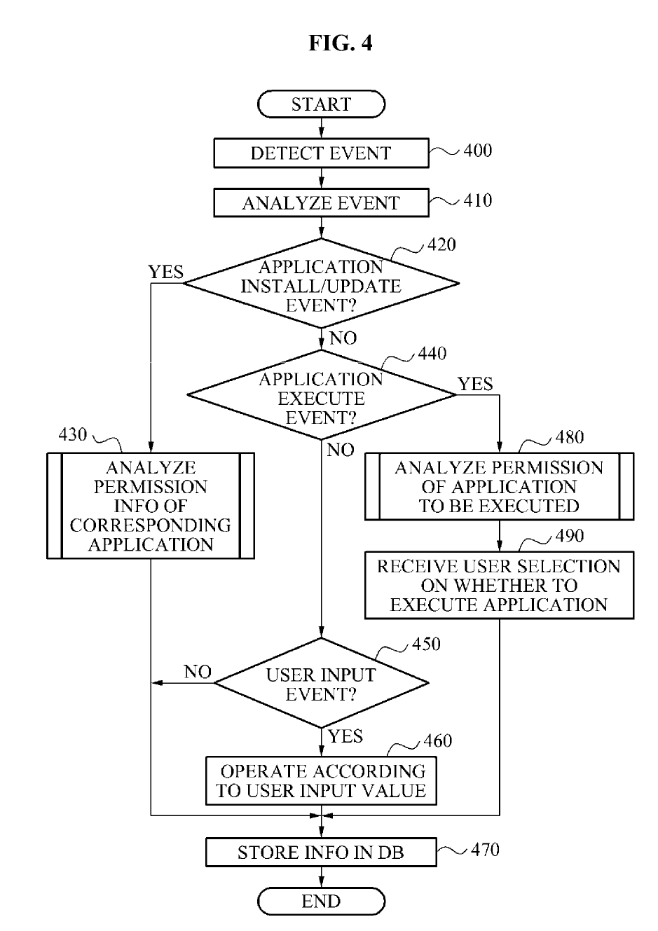

FIG. 4 is a flowchart illustrating a method for managing permission information of an application according to an exemplary embodiment of the invention.

The method of FIG. 4 will be described as if performed by the apparatus of FIG. 2, but is not limited as such.

In operation 400, the protection manager 200 may detect a reference event. In an example, the reference event may have at least one of a designated default value and a user input event indicating a received input from a user.

In operation 410, the protection manager 200 may analyze the detected event.

In operation 420, the protection manager 200 may determine whether the analyzed event is an application install/update event. In an example, the application install/update event may be referred to as an application modification event.

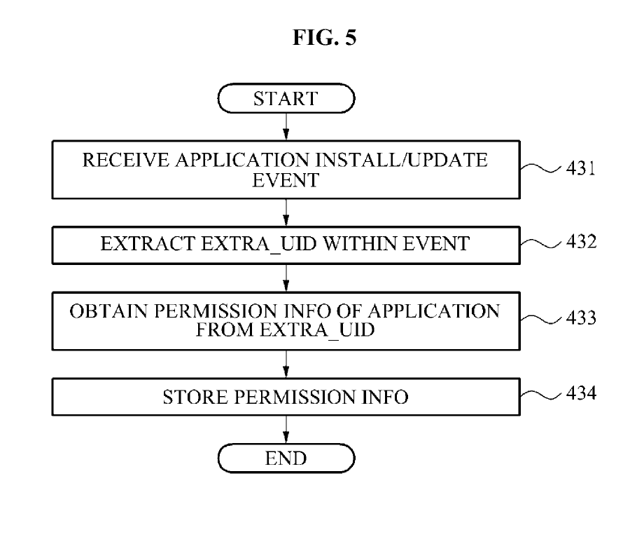

In operation 430, the protection manager 200 may analyze information associated with a corresponding application, which will be further described with reference to FIG. 5.

Alternatively, if the analyzed event is determined to not be the application install/update event in operation 420, the protection manager 200 may determine whether the event is an application execute event in operation 440.

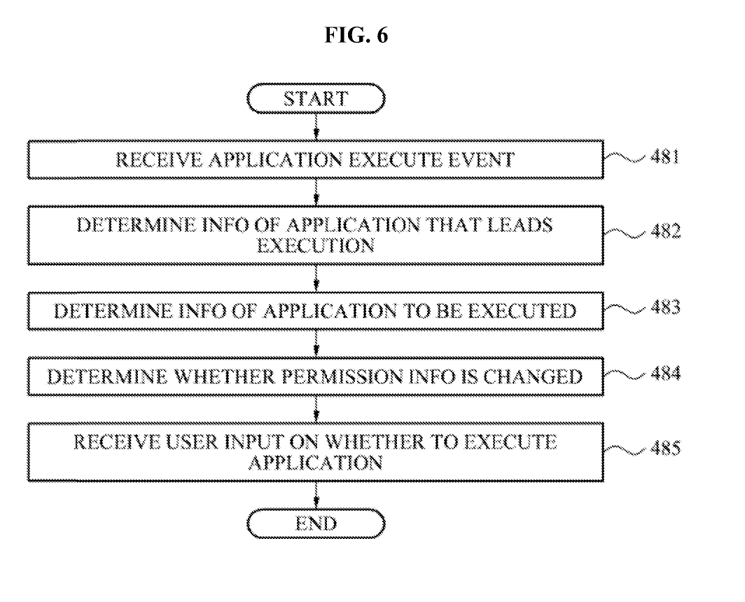

If the event is determined as the application execution event in operation 440, the protection manager 200 may analyze permission information of an application to be executed in operation 480, which will be further described with reference to FIG. 6.

In operation 490, the protection manager 200 may receive a user input or selection on whether to execute the corresponding application based on the analysis result of operation 480.

If the event is determined to not be the application execute event in operation 440, the protection manager 200 may determine whether the event is a user input event in operation 450. If the event is determined as the user input event in operation 450, the protection manager 200 may operate according to a user input value in operation 460, and may store the information related to the executed operation performance information in a database in operation 470.

FIG. 5 is a flowchart illustrating a method for analyzing information of an application according to an exemplary embodiment of the invention.

The method of FIG. 5 will be described as if performed by the apparatus of FIG. 2, but is not limited as such.

In operation 431, the protection manager 200 may receive or detect an application install/update event.

In operation 432, the protection manager 200 may extract an EXTRA_UID data value from an Intent Object within the received event. EXTRA_UID may be an identifier (ID) of an application that triggered the corresponding event.

Using the EXTRA_UID or the ID of the application, the protection manager 200 may access a package manager within the framework layer 20 and obtain permission information of the application using a Package Manager.geInstalled Package (GET_Permission) function in operation 433.

In operation 444, the protection manager 200 may store the obtained permission information of the application in the data storage unit 240.

FIG. 6 is a flowchart illustrating a method for analyzing a permission of an application to be executed according to an exemplary embodiment of the invention.

The method of FIG. 6 will be described as if performed by the apparatus of FIG. 2, but is not limited as such.

Referring to FIG. 6, the protection manager 200 may receive or detect an application execute event in operation 481.

In operation 482, the protection manager 200 may determine information associated with a first application, such as execution information, in order to execute the respective application. In operation 483, the protection manager 200 may determine information associated with a second application, such as execution information, to execute the respective application. In an example, the protection manager 200 may drive a security program to determine whether permission information of the first application and/or the second application has changed.

If the first application and the second application are determined to be the same or similar application program, the protection manager 200 may not drive the security program. If the first application is determined to be different from the second application, the protection manager 200 may drive the security program to determine whether permission information has changed.

In operation 484, the protection manager 200 may determine whether permission information has changed by comparing permission information of the first application and permission information of the second application. That is, the protection manager 200 may determine whether permission information of the first application has changed in association with the execution of the second application. Further, the protection manager 200 may determine whether permission information of the first application has changed due to execution of the second application while the first application is being executed.

Accordingly, if permission information of the first application is determined to be changed due to or in association with the execution of the second application, the protection manager 200 may receive a user input on whether to execute the second application in operation 485. If the user directs the protection manager 200 to suspend execution of the second application, the operation performing unit 250 may suspend execution of the second application. In addition, the protection manager 200 may receive a user input on whether to execute the first application. If the user directs the protection manager 200 to suspend execution of the first application, the operation performing unit 250 may suspend execution of the first application.

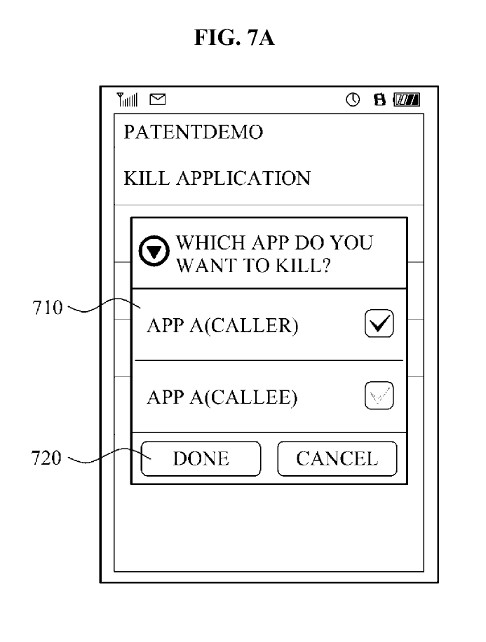

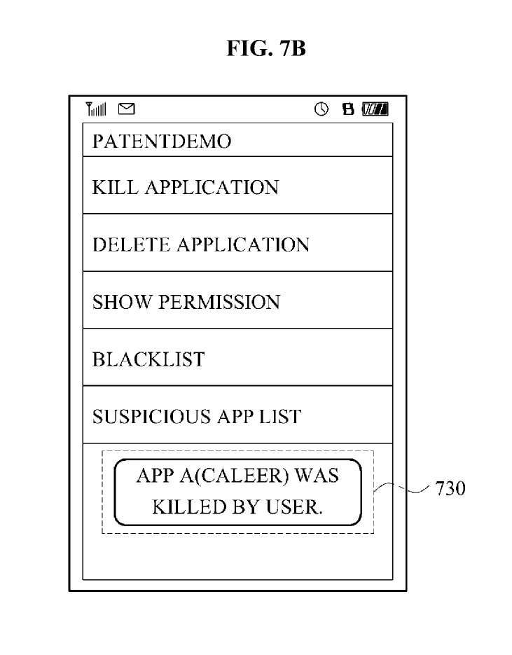

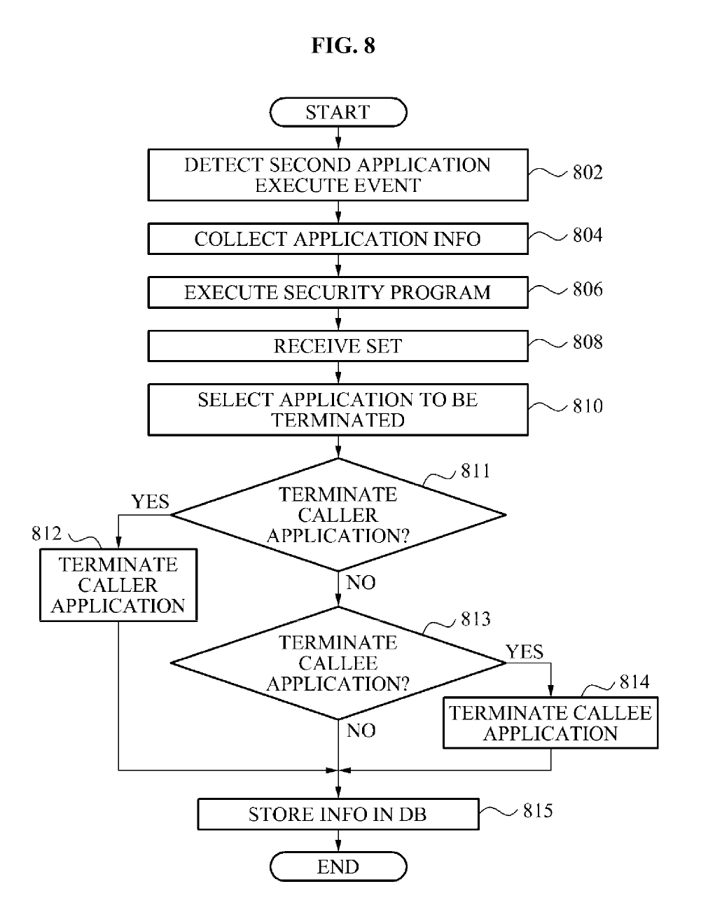

FIG. 7A and FIG. 7B are views illustrating a screen that is displayed on a terminal if an application is terminated according to an exemplary embodiment of the invention. FIG. 8 is a flowchart illustrating a method for terminating an application according to an exemplary embodiment of the invention.

The method of FIG. 8 will be described as if performed by the apparatus of FIG. 2, but is not limited as such.

Referring to FIG. 8, the protection manager 200 may detect a second application or a callee application execution event in operation 802. In an example, the protection manager 200 may detect the callee application or the second application execution event while a first application or a caller application is being executed, or independently thereof.

In operation 804, the protection manager 200 may collect information about the first application and/or the second application.

In operation 806, the protection manager 200 may execute a security program to execute a security action in response to the occurrence of an event associated with the second application.

In operation 808, the protection manager 200 may receive an instruction set, in which the first application and/or the second application are directed or selected to be terminated or killed.

In operation 810, the protection manager 200 may receive a selection of the application or applications to be terminated or killed.

If the caller application or the first application is selected to be terminated in operation 811, the protection manager 200 may terminate the caller application or the first application in operation 812. If the second application or the callee application is selected to be terminated in operation 813, the protection manager 200 may terminate the second application or the callee application in operation 814. Although both the first application and the second application are described as being displayed for selection, the first application or the second application may be displayed independently to be selected for termination. Further, if both applications are displayed, both applications may be selected for termination.

As shown in FIG. 7A, the protection manager 200 may receive a selection of an application to be terminated or killed between the first application and the second application in operation 810.

For example, referring to FIG. 7A, if the first application 710, showing as “APP A(CALLER)”, and an execution button 720 are selected, the first application may be terminated.

In operation 815, the protection manager 200 may terminate the application requested to be terminated, display a confirmation message as shown in a message box 730 of FIG. 7B, and store the termination information in a database.

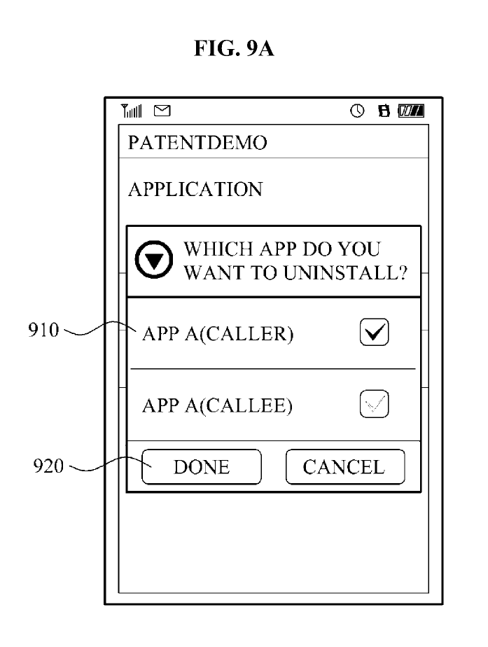

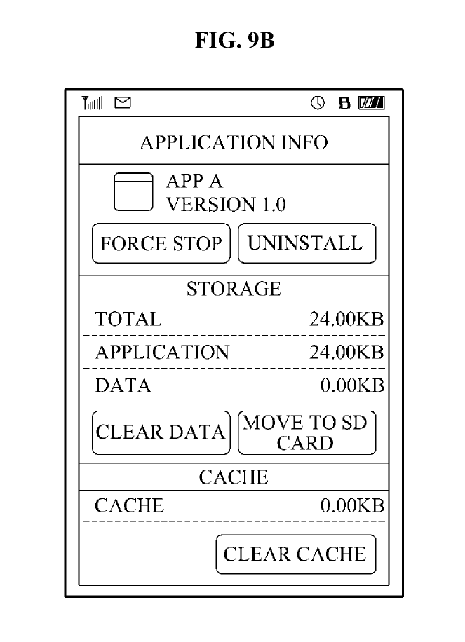

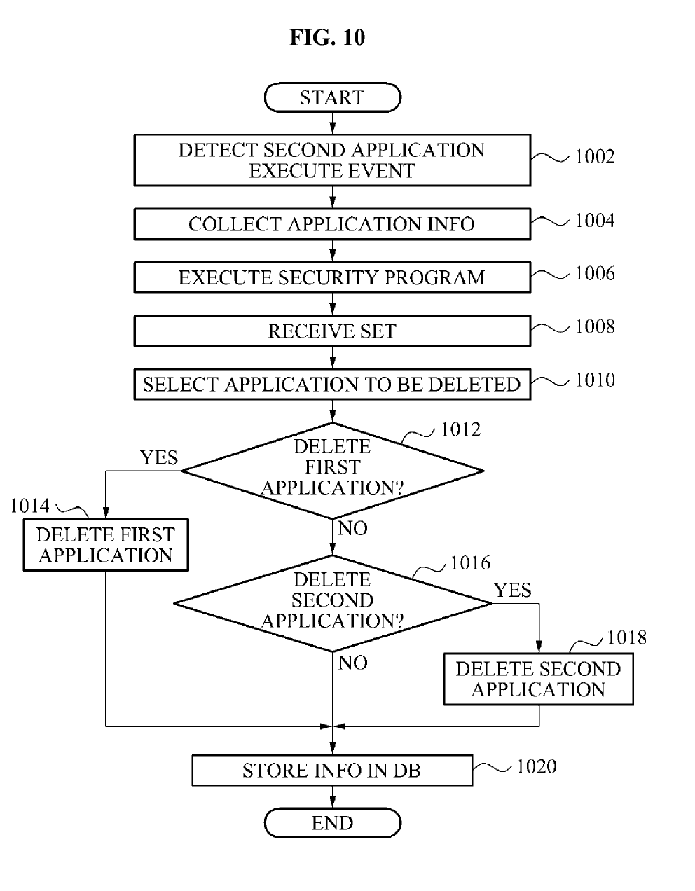

FIG. 9A and FIG. 9B are views illustrating a screen that is displayed on a terminal if an application is deleted or uninstalled according to an exemplary embodiment of the invention. FIG. 10 is a flowchart illustrating a method for deleting an application according to an exemplary embodiment of the invention.

The method of FIG. 10 will be described as if performed by the apparatus of FIG. 2, but is not limited as such.

Referring to FIG. 10, the protection manager 200 may detect a second application or a callee application execution event in operation 1002. In an example, the protection manager 200 may detect the second application execution event while a first application or a caller application is being executed, or independently thereof. The protection manager 200 may execute a security program to monitor or detect a change in permission information of the first application.

In operation 1004, the protection manager 200 may collect information about the first application and/or the second application.

In operation 1006, the protection manager 200 may execute the security program to execute a security action in response to a second application execution event.

In operation 1008, the protection manager 200 may receive an instruction set, in which the first application and/or the second application are directed or selected to be deleted or uninstalled.

In operation 1010, the protection manager 200 may receive a selection of the application or applications to be deleted or uninstalled.

If the first application is selected to be deleted in operation 1012, the protection manager 200 may delete the first application in operation 1014. If the second application is selected to be deleted in operation 1016, the protection manager 200 may delete the second application in operation 1018. Although both the first application and the second application are described as being displayed for selection, the first application or the second application may be displayed independently to be selected for deletion. Further, if both applications are displayed, both applications may be selected for deletion or uninstallation.

As shown in FIG. 9A, the protection manager 200 may receive a selection on an application to be deleted or uninstalled between the first application and the second application in operation 1010.

For example, referring to FIG. 9A, if the first application 910, showing as “APP A(CALLER)”, and an execution button 920 are selected, the first application may be deleted or uninstalled.

In operation 1020, the protection manager 200 may delete or uninstall the application requested to be deleted or uninstalled, display a corresponding interface as shown in FIG. 9B, and store the deletion or uninstall information in a database. Although the method of 10 is described with reference to deletion or uninstallation of an application, the application may be selected to be forced stop, clear data, clear cache, moved to a secure digital (SD) card, and the like.

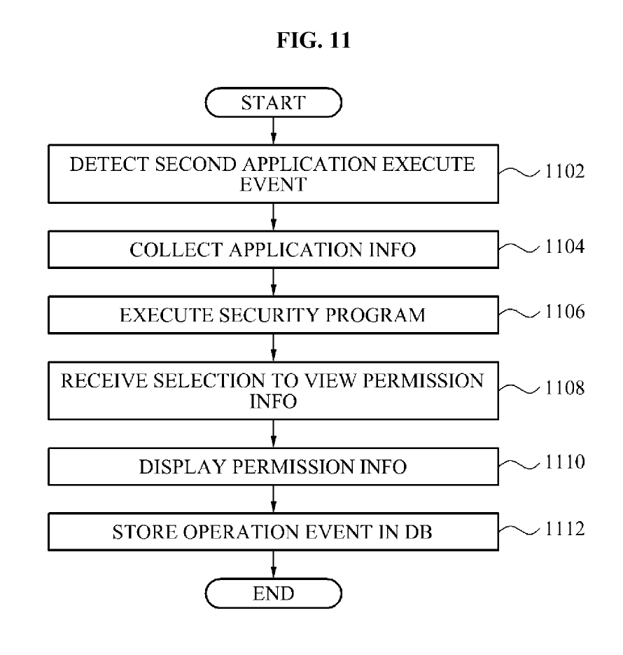

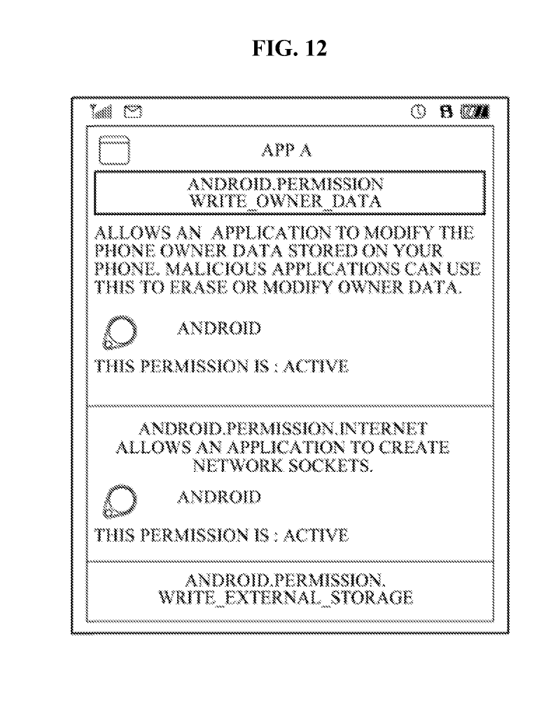

FIG. 11 is a flowchart illustrating a method for requesting permission information of an application according to an exemplary embodiment of the invention. FIG. 12 is a view illustrating a screen that is displayed on a terminal in response to a request for permission information of an application according to an exemplary embodiment of the invention.

Referring to FIG. 11, in operation 1102, the protection manager 200 may detect a second application execution event. In an example, the protection manager 200 may detect the second application execution event while a first application is being executed, or independently thereof.

In operation 1104, the protection manager 200 may collect information about the first application and/or the second application.

In operation 1106, the protection manager 200 may execute a security program to execute a security action in response to a second application execution event.

If a selection to view permission information associated with the first application and/or the second application is received in operation 1108, the protection manager 200 may display permission information of a corresponding application in operation 1110 as shown in FIG. 12.

Permission information associated with an application may include permission information used in response to execution of the application and/or corresponding content. Also, one or more permission settings of the permission information may be modified.

In operation 1112, the protection manager 200 may store an operation event for displaying the permission information in a database.

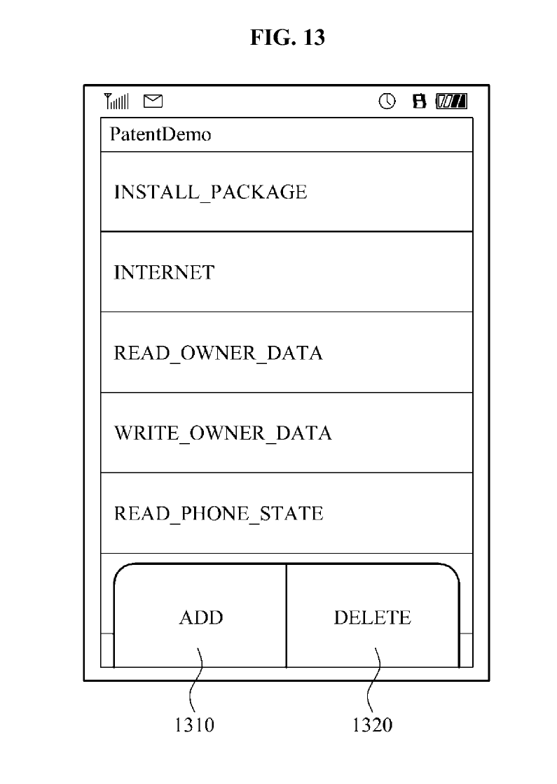

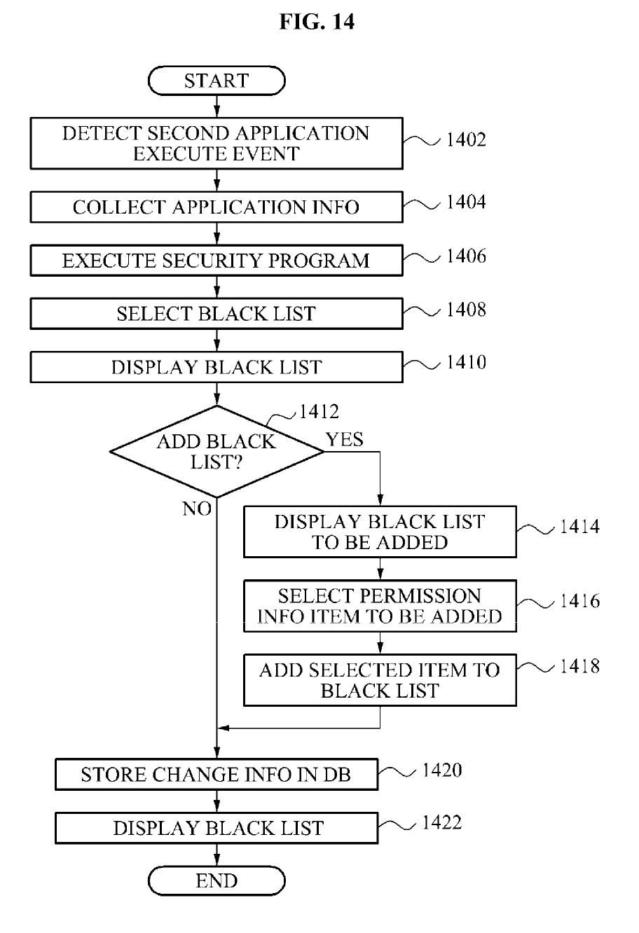

FIG. 13 is a view illustrating a screen that is displayed on a terminal if adding or deleting permission information of an application according to an exemplary embodiment of the invention. FIG. 14 is a flowchart illustrating a method for adding permission information of an application according to an exemplary embodiment of the invention.

Referring to FIG. 14, the protection manager 200 may detect a second application execution event in operation 1402. In an example, the protection manager 200 may detect the second application execution event while a first application is being executed, or independently thereof.

In operation 1404, the protection manager 200 may collect information about the first application and/or the second application.

In operation 1406, the protection manager 200 may execute a security program to execute a security action in response to a second application execution event.

In operation 1408, the protection manager 200 may receive a selection of a particular list, such as a black list, that may manage permission information arbitrarily operable by one or more applications.

In operation 1410, the protection manager 200 may display the black list, which may be stored in the data storage unit 240, as shown in FIG. 13.

As shown in a box 1310 of FIG. 13, if the protection manager 200 receives a user input to add the selected permission information item to the respective black list. Referring to FIG. 13, the protection manager 200 may receive a user input indicating a button “ADD” has been pressed, the protection manager 200 may determine the received user input as a black list add request signal in operation 1412, and may display the black list to be added on a screen in operation 1414.

In operation 1416, the protection manager 200 receives a selection of a permission information item to be added to the black list. In operation 1418, the selected permission information item may be added to the black list.

If no selection of permission information item to be added is made in operation 1412, and if the protection manager 200 receives a user input to remove the selected permission information item from the respective black list. Referring to FIG. 13, the protection manager 200 may receive a user input indicating a “DELETE” button 1320 of FIG. 13 has been pressed, to instruct the protection manager 200 to delete the selected permission information item.

Accordingly, the protection manager 200 may store, in a database, the permission information item added to or deleted from the black list, and store the changed or updated black list information in operation 1420, and display the updated black list in which the changes are reflected in operation 1422.

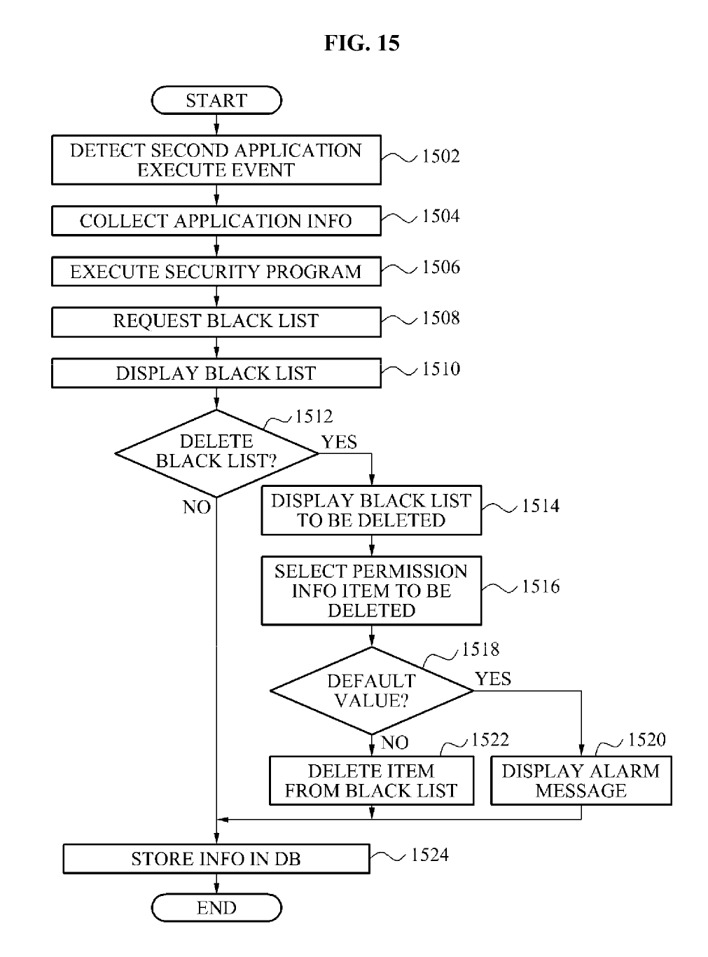

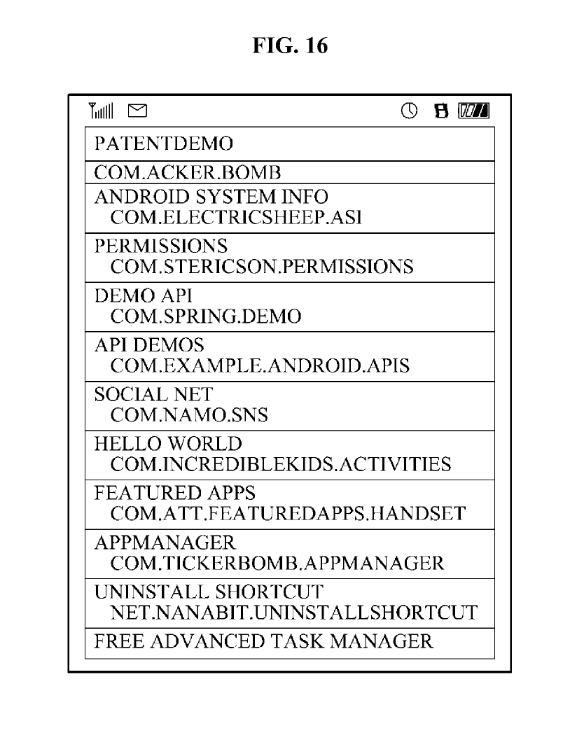

FIG. 15 is a flowchart illustrating a method for deleting permission information of an application according to an exemplary embodiment of the invention. FIG. 16 is a view illustrating a screen that is displayed on a terminal if a suspicious program is to be deleted among applications according to an exemplary embodiment of the invention.

Referring to FIG. 15, in operation 1502, the protection manager 200 may detect a second application execution event. In an example, the protection manager 200 may detect the second application execution event while a first application is being executed, or independently thereof.

In operation 1504, the protection manager 200 may collect information about the first application and/or the second application.

In operation 1506, the protection manager 200 may execute a security program to execute a security action in response to a second application execution event.

In operation 1508, the protection manager 200 may request a black list that includes permission information item or items operable by one or more unauthorized applications.

In operation 1510, the protection manager 200 may display the requested black list.

If a request signal for deleting a permission information item listed in the black list in response to a user request is detected in operation 1512, the protection manager 200 may display the black list including the permission information item to be deleted in operation 1514.

In operation 1516, the protection manager 200 may receive a selection of a permission information item to be deleted from the black list in response to the user request.

In operation 1518, the protection manager 200 may determine whether the selected permission information item is selected as a default value in response to execution of an application.

If the selected permission information item is determined to be set as the default value, the protection manager 200 may display an alarm message for restricting deletion of the corresponding permission information item in operation 1520. In response, the protection manager 200 may automatically restrict deletion of the selected permission information item, or bypass the alarm message and delete the selected permission information.

If the selected permission information item is determined not to be set as the default value, the protection manager 200 may delete the corresponding permission information item in operation 1522.

In operation 1524, the protection manager 200 may store updates or changes to the black list in a database.

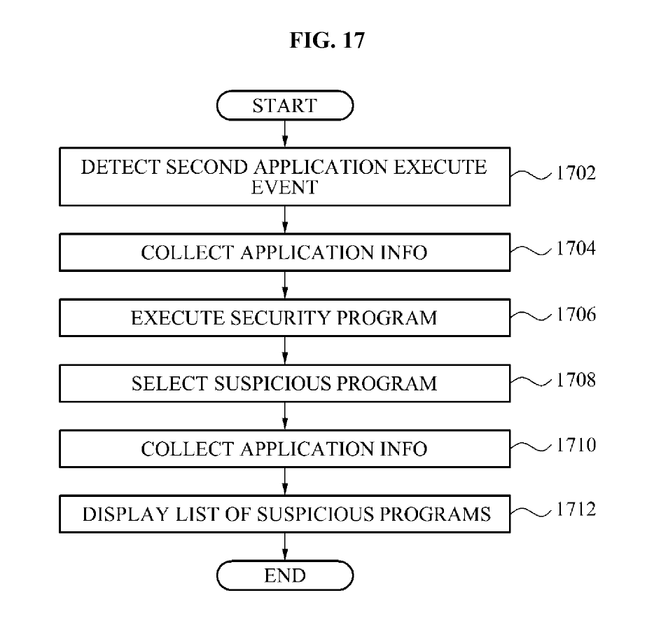

FIG. 17 is a flowchart illustrating a method for deleting a suspicious program among applications according to an exemplary embodiment of the invention.

In operation 1702, the protection manager 200 may detect a second application execution event. In an example, the protection manager 200 may detect the second application execution event while a first application is being executed, or independently thereof.

In operation 1704, the protection manager 200 may collect information about the first application and/or the second application.

In operation 1706, the protection manager 200 may execute a security program to execute a security action in response to the second application execution event.

In operation 1708, the protection manager 200 may request a list of suspicious programs stored in a database, in order to determine information about the second application.

The list of suspicious programs may include information about an application of which permission information is frequently modified, or information about an application that arbitrarily changes permission information of another application.

In operation 1710, the protection manager 200 may collect information about the second application. In operation 1712, the protection manager 200 may display the list of suspicious programs, which may include the second application. Accordingly, the protection manager 200 may determine whether the second application is included in the list of suspicious programs. If it is determined that the second application is included in the list of suspicious programs, the protection manager 200 may restrict execution of the corresponding application.

Even though an example of restricting change in permission information of an application according to operations of a plurality of applications and execution of a corresponding application is described, it may be possible to restrict execution of a corresponding application according to change in permission information of a single application.

According to exemplary embodiments of the invention, it may be possible to reduce the likelihood of permission information of a reference application from being changed due to an operation of another application, or to reduce the likelihood of the reference application from performing a reference service operation, and to restrict an operation of the application.

Also, according to exemplary embodiments of the invention, it may be possible to protect permission information set in an application, and to reduce the likelihood of a malfunctioning application.

Also, even though an operation of a security program for detecting abnormal change in permission information and an operation of a corresponding application is described, it may be possible to detect change in permission occurring if a second application temporarily pirates and uses the permission information of a first application, and to thereby restrict an operation of a corresponding application.

Also, if permission information corresponding to a reference operation of a first application is not maintained, it may be possible to temporarily pirate the permission information from a security application that maintains the permission information, and operate the corresponding application.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for managing permission information of an application in a terminal, the method comprising:
detecting a reference event associated with the application;
determining a type of the reference event;
determining permission information of the application;
determining whether to execute an operation of the application based on the permission information; and
storing operation performance information related to the operation of the application in a database.

2. The method of claim 1, further comprising:
extracting an identifier of the application from the reference event;
obtaining permission information of the application from the identifier; and
storing the permission information,
wherein the reference event type is determined to be the application modification event.

3. The method of claim 2, wherein the application modification event comprises at least one of an application installation event and an application update event.

4. The method of claim 1, further comprising:
determining execution information associated with the application;
determining whether the permission information of the application has changed;
determining whether to execute the application based on the changed permission information,
wherein the event type is determined to be the application execution event.

5. The method of claim 4, further comprising:
receiving a user input on whether to execute the application.

6. The method of claim 1, wherein the reference event is received from an Intent Object.

7. A method for managing permission information, comprising:
executing a first application;
detecting an application execution event associated with a second application;
collecting application information of the first application and the second application;
determining whether permission information of the first application has changed;
receiving an instruction set of a security action for at least one of the first application and the second application; and
executing the security action.

8. The method of claim 7, further comprising:
receiving selection information for at least one of the first application and the second application to apply the security action.

9. The method of claim 7, wherein the security program is executed in response to a determination that the first application is a different type than the second application.

10. The method of claim 7, wherein the application execution event is received from an Intent Object.

11. The method of claim 7, wherein the security action comprises at least one of termination, uninstallation, suspension, deletion and quarantine of at least one of the first application and the second application.

12. The method of claim 7, wherein the security action comprises:
comparing the second application against a list of suspicious applications based on the collected application information of the first application and the second application; and
restricting an operation of the second application if the second application is identified in the list of suspicious applications.

13. The method of claim 7, wherein the application information comprises permission information.

14. The method of claim 13, further comprising:
comparing the permission information of the second application against a black list, the black list comprising a list of permission information operable by a malicious application; and
executing the security action on the second application if the permission information of the second application is identified in the black list.

15. The method of claim 13, further comprising:
displaying a black list, the black list comprising a list of permission information items operable by one of the applications; and
receiving a selection of a permission information item to be deleted.

16. The method of claim 15, wherein if the selected permission information item corresponds to a default value, an alarm message is displayed, and if the selected permission information item does not correspond to the default value, the selected permission information item is deleted.

17. A terminal, comprising:
an application layer to execute a first application, and to detect an event associated with a second application; and
a framework layer to determine whether permission information of the first application is changed with respect to the second application, to determine an event type associated with the change in the permission information, to determine permission information of the first application and the second application, and to determine whether to execute a security program,
wherein the security program executes a security action based on the event type associated with a change in the permission information.

18. The terminal of claim 17, wherein the event type comprises at least one of an application installation event, an application update event, a user input event, and an application execution event.

19. The terminal of claim 17, wherein the security action comprises at least one of a termination of an application, uninstallation of an application, suspension of an application, deletion of an application, storing of the related permission information, and quarantine of an application.

20. The terminal of claim 17, further comprising:
a user input value receiver to receive an input in response to the security action.
